(19) United States
(12) Patent Application Publication
(10) Pub. No.: US 2023/0082365 A1
(43) Pub. Date: Mar. 16, 2023

(54) GENERATING SIMULATED AGENT TRAJECTORIES USING PARALLEL BEAM SEARCH

(71) Applicant: Waymo LLC, Mountain View, CA (US)

(72) Inventors: Kyriacos Christoforos Shiarlis, Oxford (GB); Dragomir Anguelov, San Francisco, CA (US); Brandyn Allen White, Mountain View, CA (US); Shimon Azariah Whiteson, Oxford (GB); Maximilian Igl, Manchester (GB); Daewoo Kim, Seoul (KR); Alex Richard Kuefler, San Jose, CA (US); Paul Marie Vincent Mougin, Oxford (GB); Punit Nilesh Shah, London (GB); Mark Palatucci, San Francisco, CA (US)

(21) Appl. No.: 17/947,046

(22) Filed: Sep. 16, 2022

Related U.S. Application Data
(60) Provisional application No. 63/245,175, filed on Sep. 16, 2021.

(51) Int. Cl. B60W 60/00; G05B 13/02; B60W 50/06

(52) U.S. Cl. CPC B60W 60/0027; G05B 13/027; B60W 50/06; B60W 2554/4046; B60W 2554/20

(57) ABSTRACT

Methods, systems, and apparatus, including computer programs encoded on computer storage media, for generating simulated trajectories using parallel beam search.

### CROSS-REFERENCE TO RELATED APPLICATION

This application claims priority to U.S. Provisional Application No. 63/245,175, filed on Sep. 16, 2021. The disclosure of the prior application is considered part of and is incorporated by reference in the disclosure of this application.

### BACKGROUND

This specification relates to generating trajectories for simulated agents in a simulation of a real-world environment. For example, the generated trajectories can be used to evaluate the performance of control software for an autonomous vehicle.

Autonomous vehicles include self-driving cars, boats, and aircraft. Autonomous vehicles use a variety of on-board sensors and computer systems to detect nearby objects and use such detections to make control and navigation decisions.

Some autonomous vehicles have on-board computer systems that implement neural networks, other types of machine learning models, or both for various prediction tasks, e.g., object classification within images. For example, a neural network can be used to determine that an image captured by an on-board camera is likely to be an image of a nearby car.

### SUMMARY

This specification generally describes a system implemented as computer programs on one or more computers in one or more locations that generates simulated trajectories for agents, e.g., vehicles, cyclists, pedestrians, and so on, interacting in a simulated environment, i.e., in a computer simulation of a real-world environment.

The subject matter described in this specification can be implemented in particular embodiments so as to realize one or more of the following advantages.

Simulation, i.e., computer simulations of real-world driving scenarios, is a crucial tool for accelerating the development of autonomous driving software because it can generate adversarial interactions for training autonomous driving policies, play out counterfactual scenarios of interest, and estimate safety-critical metrics. In this way, simulation reduces reliance on real-world data, which can be expensive and/or dangerous to collect, for evaluating control software for autonomous vehicles, training models that will be deployed on autonomous vehicles, or both.

As autonomous vehicles share public roads with human drivers, cyclists, and pedestrians, the underlying simulation tools require realistic models of these human road users. Thus, for simulation to be useful, the simulated trajectories need to be both realistic, i.e., so that they can mirror scenarios that can plausibly be encountered in the real-world and diverse, i.e., so that they mirror scenarios that are plausible but different from one another.

However, existing techniques for generating simulated trajectories, e.g., based on an initial set of reference (or “demonstration”) real-world trajectories, are typically insufficient. For example, they can yield policies that generate simulated trajectories where agents frequently collide or drive off the road. To address this problem, the described techniques greatly improve realism by introducing a parallel beam search in the process of generating simulated trajectories. The beam search refines partial trajectories on the fly by pruning partial trajectories that are unfavorably evaluated, e.g., by a discriminator.

In some implementations, however, using only parallel beam search can result in trajectories with insufficient diversity, i.e., that do not sufficiently represent the entire distribution of realistic behavior in a given driving scene, as pruning can encourage mode collapse. The described techniques address this issue with a hierarchical approach, factoring agent behavior into goal generation and goal conditioning. The use of such goals ensures that agent diversity neither disappears during training nor is pruned away by the beam search.

Thus, the described techniques can generate a large number of simulated trajectories given a relatively small set of reference trajectories and, moreover, generate simulated trajectories that are realistic and diverse and that are therefore significantly more useful for downstream tasks than those generated by conventional approaches.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system.

FIG. 2 is a flow diagram of an example process for generating simulated trajectories from an initial state.

FIG. 3 is a flow diagram of an example process for updating a partial trajectory.

FIG. 4 is a flow diagram of an example process for generating a score for a partial trajectory.

FIG. 5 shows an example of generating a set of simulated trajectories.

Like reference numbers and designations in the various drawings indicate like elements.

### DETAILED DESCRIPTION

This specification describes how a system can generate multiple realistic, diverse simulated trajectories starting from a given initial state in which multiple simulated agents are present in a simulated environment, i.e., an environment that is a computer simulation of a real-world environment.

In this specification, an “agent” can refer, without loss of generality, to a vehicle, bicycle, pedestrian, ship, drone, or any other moving object in an environment.

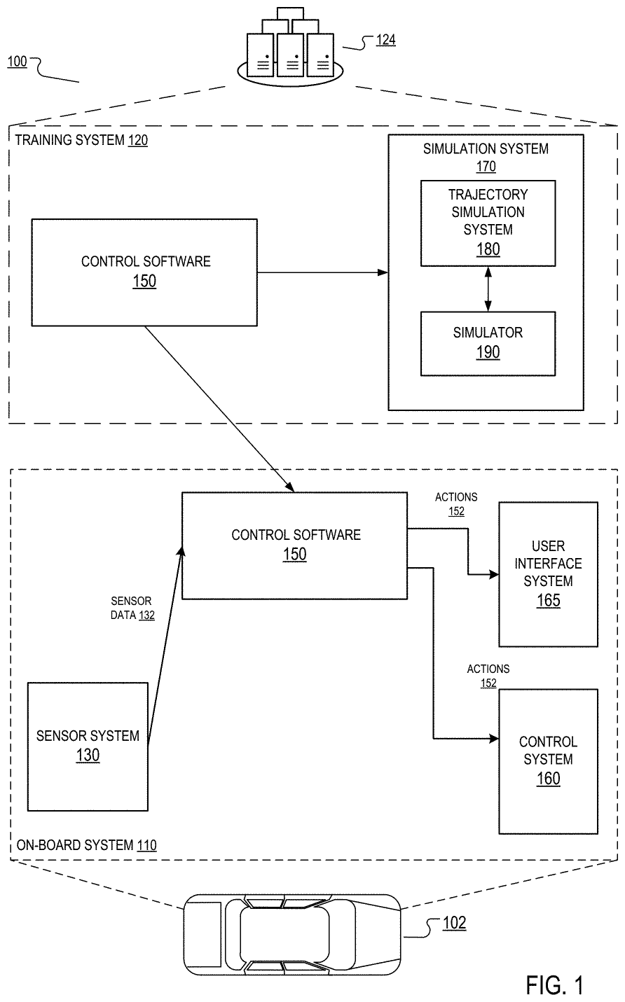

FIG. 1 is a diagram of an example system 100. The system 100 includes an on-board system 110 and a training system 120.

The on-board system 110 is located on-board a vehicle 102. The vehicle 102 in FIG. 1 is illustrated as an automobile, but the on-board system 102 can be located on-board any appropriate vehicle type.

In some cases, the vehicle 102 is an autonomous vehicle. An autonomous vehicle can be a fully autonomous vehicle that determines and executes fully-autonomous driving decisions in order to navigate through an environment. An autonomous vehicle can also be a semi-autonomous vehicle that uses predictions to aid a human driver. For example, the vehicle 102 can autonomously apply the brakes if a prediction indicates that a human driver is about to collide with another vehicle. As another example, the vehicle 102 can have an advanced driver assistance system (ADAS) that assists a human driver of the vehicle 102 in driving the vehicle 102 by detecting potentially unsafe situations and alerting the human driver or otherwise responding to the unsafe situation. As a particular example, the vehicle 120 can alert the driver of the vehicle 102 or take an autonomous driving action when an obstacle is detected, when the vehicle departs from a driving lane, or when an object is detected in a blind spot of the human driver.

The on-board system 110 includes one or more sensor subsystems 130. The sensor subsystems 130 include a combination of components that receive reflections of electromagnetic radiation, e.g., lidar systems that detect reflections of laser light, radar systems that detect reflections of radio waves, and camera systems that detect reflections of visible light.

The sensor data generated by a given sensor generally indicates a distance, a direction, and an intensity of reflected radiation. For example, a sensor can transmit one or more pulses of electromagnetic radiation in a particular direction and can measure the intensity of any reflections as well as the time that the reflection was received. A distance can be computed by determining how long it took between a pulse and its corresponding reflection. The sensor can continually sweep a particular space in angle, azimuth, or both. Sweeping in azimuth, for example, can allow a sensor to detect multiple objects along the same line of sight.

The sensor subsystems 130 or other components of the vehicle 102 can also classify groups of one or more raw sensor measurements from one or more sensors as being measures of another agent. A group of sensor measurements can be represented in any of a variety of ways, depending on the kinds of sensor measurements that are being captured. For example, each group of raw laser sensor measurements can be represented as a three-dimensional point cloud, with each point having an intensity and a position in a particular two-dimensional or three-dimensional coordinate space. In some implementations, the position is represented as a range and elevation pair. Each group of camera sensor measurements can be represented as an image patch, e.g., an RGB image patch.

Once the sensor subsystems 130 classify one or more groups of raw sensor measurements as being measures of respective other agents, the sensor subsystems 130 can compile the raw sensor measurements into a set of sensor data 132, and send the sensor data 132 to control software 150.

The control software 150 uses the set of sensor data 132 to make control decisions or control recommendations for the vehicle 112, i.e., to select an action 152 or a trajectory of multiple future actions 152 to be performed by the vehicle 152 given the current state of the environment as reflected by the sensor data 132. The actions 152 can be high-level actions, e.g., “turn left,” “go straight,” “slow down,” or “accelerate”, or can be low-level controls, i.e., control inputs for the steering or braking systems of the vehicle.

The control software 150 can include a variety of software components that it uses to make control decisions. For example, the control software 150 can include one or more trained machine learning models, e.g., neural networks or other types of machine learning models. An example of a neural network that can be included as part of the control software 150 includes a behavior prediction neural network that predicts the future behavior of other agents in the environment given the sensor data 132. Another example of a neural network that can be included as part of the control software 150 is an trajectory planning neural network that generates a planned trajectory for the vehicle 102 that can be safely followed by the vehicle given an intended route and given the states of other agents in the environment as reflected by the sensor data 132.

Once the control software 150 has generated action(s) 152, the control software 152 can provide data specifying the action(s) 152 to a control system 160 for the vehicle, a user interface system 165, or both.

When the control system 160 receives the action(s) 152, the control system 160 can autonomously control the steering of the vehicle, the braking of the vehicle, or both, to carry out the actions.

When the user interface system 165 receives the action(s) 152, the user interface system 165 can use the action(s) 152 to present information to the driver of the vehicle 102 to assist the driver in operating the vehicle 102 safely. The user interface system 165 can present information to the driver of the agent 102 by any appropriate means, for example, by an audio message transmitted through a speaker system of the vehicle 102 or by alerts displayed on a visual display system in the agent (e.g., an LCD display on the dashboard of the vehicle 102). In a particular example, the action(s) 152 may indicate that the vehicle 102 should yield to a nearby vehicle. In this example, the user interface system 165 can present an alert message to the driver of the vehicle 102 with instructions to adjust the trajectory of the vehicle 102 to yield or notify the driver of the vehicle 102 that a collision with a particular surrounding agent is likely unless the vehicle 102 yields.

The training system 120 is typically hosted within a data center 124, which can be a distributed computing system having hundreds or thousands of computers in one or more locations.

The training system 120 can be used to evaluate the control software 150 before the control software is deployed on-board the vehicle, to train one or more of the machine learning models that are included as components of the control software 150, or both.

In particular, the training system 120 includes a simulation system 170 that generates computer simulations of real-world driving scenarios that can be encountered by the vehicle 102 or other vehicles while navigating in the real-world environment.

In other words, the simulation system 170 generates simulated trajectories that can then be used for a downstream task that improves the operation of the vehicle 112.

Each simulated trajectory starts at a respective joint state of the simulated environment, i.e., of the simulation of the real-world environment that includes a plurality of agents, e.g., an ego agent and one or more other agents. The “ego agent” can be a model of the vehicle 102 or another vehicle that has sensors that repeatedly measure the environment.

A “joint state” of the simulated environment is information characterizing the environment at a corresponding time point.

The joint state generally includes data that is common to all of the agents at the corresponding time point, e.g., static scene features and dynamic scene features, and data characterizing the states of the simulated agents in the environment at the corresponding time point and, optionally, one or more preceding time points. Static scene features can include locations of lanes and sidewalks in the simulated environment, e.g., a roadgraph that is represented as a set of interconnected lane regions with ancestor, descendant, and neighbour relationships that describes how agents can move, change lanes, and turn within the environment.

Dynamic scene features can include traffic light states at the corresponding time point and optionally other information.

The dynamic scene features and the states of the simulated agents can be simulations of what would be measured by the sensors of the ego agent in the corresponding state of the real environment.

At each time step in a given simulated trajectory, each agent performs an action given the current state of the environment and the simulated environment transitions into a new joint state.

The transition from the new joint state given the current state and a joint action that includes the actions for all of the agents is governed by a transition function for the simulated environment. That is, the transition function receives as input the current state and the joint action and generates as output the new state of the environment.

The simulation system 170 can represent the transition function using a simulator 190 of the real-world environment, i.e., one or more computer programs that represent the transition function and that receive as input a joint state and a joint action and output a new joint state that simulates the state of the real-world environment if the joint action were performed when the real-world environment were in the joint state. The simulator 190 can be any appropriate machine-learned or heuristic-based software that approximates the underlying transition function for the real-world environment.

As used in this specification, a trajectory for an agent is a sequence that includes a respective agent state for the agent for each of a plurality of time points. Each agent state identifies at least a waypoint location for the corresponding time point, i.e., identifies a location of the agent at the corresponding time point. In some implementations, each agent state also includes other information about the state of the agent at the corresponding time point, e.g., the heading of the agent at the corresponding time point, the speed of the agent, the acceleration of the agent, and so on.

The simulation system 170 also includes a trajectory simulation system 180.

The trajectory simulation system 180 is a system that receives as input an initial joint state at an initial time step and interacts with the simulator 190 to generate multiple simulated trajectories that each start at the initial joint state but that collectively represent multiple different, realistic scenarios that could have occurred in the real-world starting from the initial joint state.

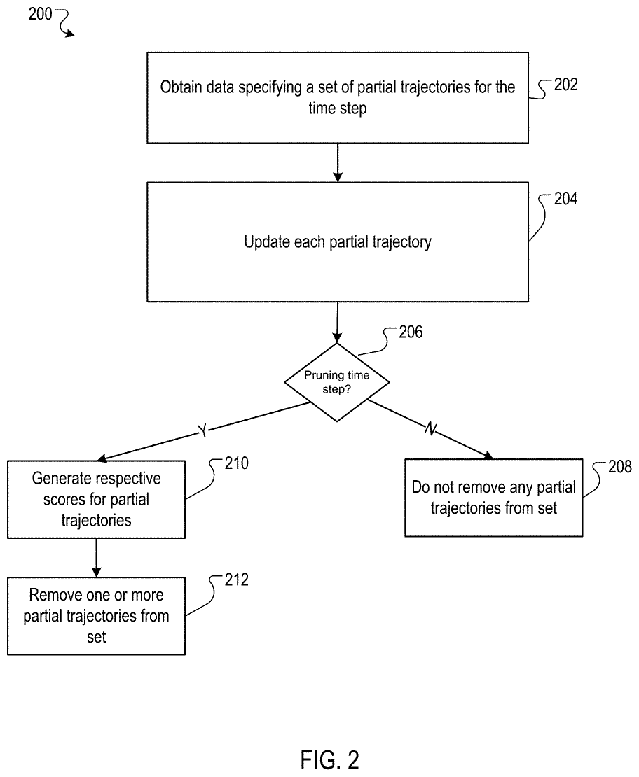

Generating these simulated trajectories is described in more detail below with reference to FIGS. 2-5.

By making use of the simulation system 170, the training system 120 can generate simulated trajectories that represent adversarial interactions for training autonomous driving policies, that play out counterfactual scenarios of interest, and that estimate safety-critical metrics. In this way, simulation reduces reliance on real-world data, which can be expensive and/or dangerous to collect.

However, as described above, in order to be useful for downstream tasks, the simulated trajectories need to be realistic and to capture a diverse range of plausible agent behavior in any given driving scenario.

Thus, as will be described in more detail below, the system 180 uses a parallel beam search technique to generate the multiple trajectories. In particular, the system 180 iteratively updates each partial trajectory in a set (“beam”) of partial trajectories and, at some time steps, prunes the set to remove partial trajectories that are unlikely to satisfy certain criteria.

Once generated, the simulated trajectories that are generated by the trajectory simulation system 180 can be used to evaluate the performance of the control software 150 before the control software 150 is deployed on-board the autonomous vehicle.

For example, when generating the simulated trajectories, a given one of the simulated agents, e.g., the ego agent, can be controlled using the control software 150, e.g., the joint action generated at each time step can include, for the given one of the simulated agents, an action that was proposed by the control software 150. From the generated trajectories, it can be determined whether the simulated trajectories satisfy certain criteria as part of determining whether to deploy the control software 150 on-board the vehicle 102.

As another example, the outputs of the control software 150 given the state data in the simulated trajectories can be compared to the actions performed by one or more of the simulated agents in the simulated trajectories to determine whether the control software 150 satisfies certain criteria as part of determining whether to deploy the control software on-board the vehicle.

The simulated trajectories that are generated can also or instead be used as training data for one or more neural networks or other machine learning models that are part of the control software 150. That is, the simulated trajectories can be used to train one or more neural networks, e.g., neural networks that predict the behavior of agents in the environment or neural networks that predict planned trajectories for the autonomous vehicle, and the neural networks, after training, can be deployed on-board the autonomous vehicle 102 for use in controlling the autonomous vehicle 102.

FIG. 2 is a flow diagram of an example process 200 for generating multiple simulated trajectories from a single initial joint state. For convenience, the process 200 will be described as being performed by a system of one or more computers located in one or more locations. For example, a training system, e.g., the training system 120 of FIG. 1, appropriately programmed in accordance with this specification, can perform the process 200.

Generally, the system obtains initial state data specifying an initial state of the simulated environment (a “joint state”). When in the initial state, the simulated environment includes a plurality of simulated agents at an initial time step.

Generally, the initial state corresponds to a reference trajectory. For example, the reference trajectory can be a real-world, observed trajectory from the real-world environment. As a particular example, the reference trajectory can be a real-world trajectory in which a particular driving scenario occurred, e.g., a lane merge, a near-collision, or a collision. When the reference trajectory is a real-world trajectory, the information in the initial state can correspond to the initial state in the real-world trajectory and can be derived in part from sensor measurements captured by the sensors of an ego agent, e.g., an autonomous vehicle in the real-world environment.

As another example, the reference trajectory can be an already-generated simulated trajectory. As a particular example, the simulated trajectory can be a modified version of a real-world trajectory, e.g., in which the states of one or more of the agents have been perturbed or otherwise modified. When the reference trajectory is a simulated trajectory, the information in the initial state can correspond to the initial state in the simulated trajectory and can be derived in part from a simulation of sensor measurements that would be captured by the sensors of an ego agent, e.g., an autonomous vehicle, if the scene occurred in the real-world environment.

The system also receives data designating one or more of the agents in the initial scene in the environment as interactive agents. In some cases, all of the agents are interactive agents. In some other cases, only a proper subset of the agents are interactive agents. An interactive agent, as will be evident from the description below, is an agent whose actions over the course of the simulated trajectory are determined by the system.

Agents who are not interactive agents can include “playback” agents whose actions are fixed to be the same as the actions of that agent in the reference trajectory, “control software-controlled”agents whose actions are determined by control software that is being tested, or both.

The system then initializes a set of a fixed number of partial trajectories that each, initially, include only the initial state of the environment, and repeatedly performs the following steps across multiple time steps to update the partial trajectories in the set.

The system obtains data specifying the set of partial trajectories for the time step (step 202). At the first time step, the set of partial trajectories is the set of trajectories that each only include in the initial state. At each subsequent time step, the set of partial trajectories is the set after being updated at the preceding time step.

The system updates each partial trajectory in the set (step 204).

At a high level, the system updates each trajectory by selecting a joint action that includes a respective action for each of the plurality of agents and then “querying” the transition function to obtain data characterizing a new state that the environment transitions into as a result of the joint action being performed when the environment is in the most recent state in the partial trajectory.

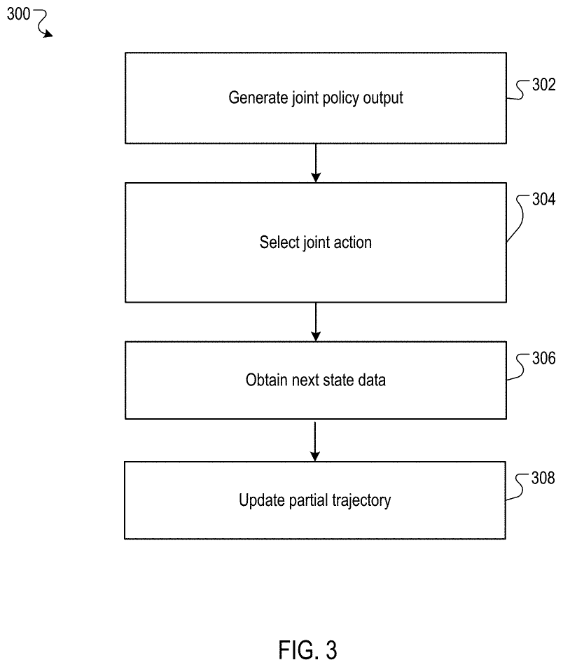

Updating the partial trajectories will be described in more detail below with reference to FIG. 3.

The system determines whether the current time step is a pruning time step (step 206). For example, every N time steps can be designated as pruning time steps, where N is an integer greater than or equal to one. As a particular example, N can be equal to 5, 10, or 15 time steps.

If the current time step is not a pruning time step, the system does not remove any partial trajectories from the set (step 208) and proceeds to the next time step.

If the current time step is a pruning time step, the system determines a respective score for each partial trajectory in the set (step 210). The score for a given trajectory represents the likelihood that the partial trajectory satisfies one or more criteria for the simulated trajectories.

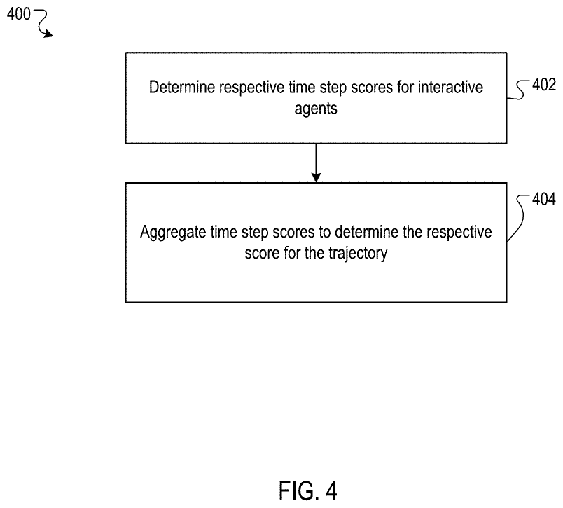

For example, as described above, it is important that the simulated trajectories be realistic, i.e., are trajectories that are can plausibly be observed in the real-world. Thus, as a particular example, the system can score each partial trajectory using a discriminator neural network that has been trained to distinguish between real-world trajectories and simulated trajectories. An example of scoring trajectories using a discriminator is described below with reference to FIG. 4.

As another example, the criteria can include one or more other criteria instead of or in addition to realism. For example, if the reference trajectory was selected because a specific driving scenario, e.g., a merge, a yield, an unprotected left turn, and so on, occurred during the trajectory, the criteria can be based on whether the driving scenario also occurs in the partial trajectory.

The system then removes one or more partial trajectories from the set of partial trajectories based on the respective scores (step 212). For example, the system can remove any trajectory that has a score that satisfies a threshold, e.g., is higher than the threshold when lower scores are better or is lower than the threshold when higher scores are better, or can remove a specified number of trajectories that have the worst scores.

After removing the partial trajectories, the system replaces the removed trajectories so that the set still includes the same number of trajectories. As a particular example, for each of the one or more partial trajectories that were removed from the set, the system can replace the partial trajectory in the set with a copy of one of the partial trajectories that was not removed from the set. That is, because simulations happen in parallel, promising branches can be duplicated during execution to replace unpromising ones, focusing computation on the most realistic rollouts.

FIG. 3 is a flow diagram of an example process 300 for updating a partial trajectory. For convenience, the process 300 will be described as being performed by a system of one or more computers located in one or more locations. For example, a training system, e.g., the training system 120 of FIG. 1, appropriately programmed in accordance with this specification, can perform the process 300.

In particular, at each time step, the system performs the process 300 for each partial trajectory in the set to update each of the partial trajectories. The system can perform the process 300 in parallel for each of the partial trajectories.

As described above, at the beginning of each time step, each partial trajectory has respective state data that characterizes the state of the environment after the most recent action in the partial trajectory was performed.

The state data characterizing the state of the environment at any given time step includes (i) static scene features of the simulated environment (ii) dynamic scene features of the simulated environment at the given time step and (iii) respective state features for each of the simulated agents at the given time step that represent the agent state at the given time step. The state features for a given agent can include features representing the location of the agent at the time step and, optionally, other features, e.g., the heading of the agent, the velocity or accelerator of the agent, the state of one or more of the sensors of the agent, and so on.

The system generates, from the respective state data for the time step in the partial trajectory, a joint policy output (step 302). The joint policy output specifies joint action that includes a respective action for each of the plurality of agents.

Generally, one or more of the simulated agents that are present in the initial state of the environment are designated as interactive agents. In some cases, all of the agents are simulated agents while, in other cases, only a proper subset of the agents are designated as interactive agents.

To generate the joint policy output, the system generates, for each interactive agent and from the respective state data at the time step, a policy input that characterizes the respective state of the simulated environment at the particular time step relative to the interactive agent. For example, the system can generate the policy input for a given input by transforming the state for the given time step and, optionally, the state data for one or more preceding time step into an agent-centric coordinate frame for the given agent, i.e., a coordinate system that is centered at the position of the given agent at the given time step. That is, an input characterizing a state “relative to” a given agent can refer to representing the features of the state in an agent-centric coordinate frame for the given agent. Optionally, an input that characterizes a state “relative to” a given agent can also only include features of scene elements, e.g., objects or other elements, that are located within a specified distance of the given agent in the environment.

The system then processes the policy input using a policy neural network.

The policy neural network is a neural network that is configured to process the policy input to generate a policy output that defines an action to be performed by the agent at the time step. As described above, the actions can include high-level actions or low-level control inputs, e.g., accelerations and steering angles. In these cases, the policy output can be a probability distribution or other score distribution over the actions. In some other cases, the system represents the actions as displacements within the environment, e.g., uses a continuous action space that specifies x, y displacements within the environment. In these cases, the policy output can be a regressed displacement for the agent.

The policy neural network can have any appropriate architecture that allows the neural network to map the policy input to a policy output. For example, the policy neural network can have an encoder neural network that maps the features in the input to an encoded representation and a policy neural network head that maps the encoded representation to the policy output.

As a particular example, the policy neural network can, for each interactive agent, encode objects (such as other cars, pedestrians and cyclists) as well as static and dynamic features are all individually using multilayer perceptrons (MLPs), followed by max-pooling across inputs of the same type to generate type-specific embeddings. The policy neural network can also encode the features of the interactive agent using another MLP and provide a concatenation of the encoded interactive agent features and the type-specific embeddings as the encoded representation. The policy head can be another MLP that processes the encoded representation to generate the policy output.

When only a proper subset of the simulated agents are designated as interactive agents, for each agent that is not an interactive agent, the joint action assigns, to the non-interactive agent, the action performed by the corresponding agent in the reference environment at a time step in the reference trajectory that corresponds to the time step.

In some cases, the policy neural network is a “goal-conditioned” policy. That is, the policy input at each time step includes a goal to be performed by the agent during the simulated trajectory. For example, the policy head can process an encoding of the goal to be performed by the agent along with the encoded representation for the agent to generate the policy output.

While different agents can have different goals, the goal for any given agent is generally static. That is, the system generates the goal for a given agent before performing the first iteration of the process 300 and uses the same goal for the given agent at each iteration of the process 300, i.e., to generate each joint policy output for each time step.

As a particular example, the goal to be performed by the agent can be a route to be travelled by the agent over the sequence of time steps in the simulated trajectory. For example, the goal can be represented as a sequence of roadgraph lane segments starting at a lane segment corresponding to an initial state of the agent when the simulated environment is in the initial state.

To generate the goal for a given interactive agent, the system can generate, from the data specifying the initial state, a goal input for the agent that characterizes the initial state of the simulated environment relative to the interactive agent and process the goal input using a goal generating policy neural network to generate a score distribution over a set of possible goals to be performed by the agent. The goal neural network can have any appropriate architecture that allows the neural network to map the goal input to a goal output. For example, the goal neural network can have an architecture similar to that of the policy neural network.

The system can then select the goal to be performed by the agent from the set of possible goals using the scores, e.g., by selecting the highest-scoring goal or by sampling a goal from the distribution. Optionally, prior to selecting the goal, the system can mask out, i.e., set to zero, the score for all goals that are not feasible for the agent given the agent's initial state, e.g., that would violate traffic laws or would require driving off of the roadway.

The system or another training system can have trained the goal generating neural network to match a distribution of goals occurring in training data generated from observed trajectories of agents in the real-world environment. That is, the goal generating neural network has been trained so that the score distribution matches a distribution over possible goals that would have been traveled by agents in the real-world environment, given the initial state of the agent.

Thus, generating a goal using the goal generating neural network ensures that the policy neural network is conditioned on realistic goals that would have actually been targeted by real-world agents.

Generally, the system or the another training system can have trained the policy neural network using training data that includes at least training data generated from observed trajectories of agents in the real-world environment, i.e., so that the policy neural network generates policy outputs that match likely actions that would be performed by real agents given the current state of the environment and, optionally, given that they have the goal specified in the policy input.

For example, the system or the other training system can have trained the policy neural network through behavior cloning on at least training data generated from observed trajectories of agents in the real-world environment. As another example, the training data can also include training data generated from simulated trajectories. For example, during the training, the system or the training system can have generated the simulated trajectories using the process 200, i.e., so that the simulated trajectories become more “realistic” as training progresses.

As another example, the system or the other training system can have trained the policy neural network through model-based generative adversarial imitation learning (MGAIL) on training data generated from observed trajectories of agents in the real-world environment and training data generated from simulated trajectories, e.g., trajectories generated by performing the process 200, i.e., so that the simulated trajectories become more “realistic” as training progresses.

When not all of the agents are interactive agents, the joint action assigns the same action to the non-interactive agent and that action is not determined by the system. For example, for each playback agent, each joint action assigns to the agent the action performed by the corresponding agent in the reference environment at a time step in the reference trajectory that corresponds to the particular time step. For each control software-controlled agent, each joint action assigns to the agent the action generated by the control software for the agent in response conditioned on the current environment state.

The system selects a joint action from the joint policy output (step 304).

For example, the system can select an action for each interactive agent using the policy output for that interactive agent, e.g., by selecting the regressed action, by sampling from the score distribution, or by selecting the highest-scoring action in the score distribution. For each non-interactive agent, the system can use, as the action for the non-interactive agent in the joint action, the assigned action for the agent as described above.

The system obtains, using a transition function for the simulated environment, next state data characterizing a next state of the environment at a next time step given that the sampled joint action is performed by the plurality of agents when the simulated environment is in the respective state characterized by the respective state data at the particular time step in the partial trajectory (step 306). As described above, the system can provide data specifying the respective state data and the sampled joint action to a simulator that represents the transition function and obtain, in response, the next state data. That is, the system can obtain updated state features for each of the agents in the environment and updated dynamic features characterizing updated states of the dynamic elements within the environment.

The system updates the partial trajectory to include the selected joint action for the particular time step and the next state data characterizing the next state of the environment at the next time step (step 308).

FIG. 4 is a flow diagram of an example process 400 for determining a respective score for a partial trajectory at a pruning time step. For convenience, the process 400 will be described as being performed by a system of one or more computers located in one or more locations. For example, a training system, e.g., the training system 120 of FIG. 1, appropriately programmed in accordance with this specification, can perform the process 400.

The system can perform the process 400 for each partial trajectory in the set at each pruning time step. As described above, the system can then use the respective scores to “prune” the set of partial trajectories.

The system determines, for each time step after the most recent pruning time step, i.e., a most recent time step at which the set of trajectories was pruned, a respective time step score for each interactive agent from the next state data that was added to the partial trajectory at the time step (step 402). As described above, in some cases, all of the agents are interactive agents while, in other cases, only a proper subset of the agents are interactive agents.

That is, for each interactive agent, the system determines a respective time step score for the pruning time step and for any other time steps that are after the immediately preceding pruning time step.

Generally, the time step score for a given time step for a given interactive agent represents the degree to which the state of the agent at the given time step satisfies the one or more criteria.

As a particular example, to generate the time step score for a given agent and for a given time step, the system can generate, from the next state data that was added to the partial trajectory at the time step, a discriminator input.

The discriminator input characterizes the respective next state of the simulated environment relative to the given interactive agent at the given time step.

The system then processes the discriminator input using a discriminator neural network. The discriminator neural network is a neural network that is configured to process the discriminator input to generate as output a discriminator score that represents the likelihood that the discriminator input was generated from state data characterizing an observed state of the real-world environment rather than a state of the simulated environment.

That is, the discriminator score represents the likelihood that the discriminator input characterizes a “real” environment state that actually occurred in the real-world rather than a synthetic state that was generated by the simulator. In some cases, higher discriminator scores indicate a greater likelihood of a real state while in other cases, lower discriminator scores indicate a greater likelihood of a real state.

The discriminator neural network can have any appropriate architecture that allows the neural network to map the discriminator input to a discriminator score. For example, the discriminator neural network can have an architecture similar to that of the policy neural network described above. As another example, the discriminator can have a simpler encoder that applies max pooling across encodings of features for all objects and scene points within a specified distance of the interactive agent at the corresponding time point.

The system or a training system can train the discriminator neural network using any of a variety of techniques to allow the discriminator to effectively predict whether a given discriminator input characterizes a “real” state.

As a particular example, the discriminator neural network can have been trained jointly with the policy neural network described above in a generative adversarial network (GAN) framework, i.e., as the discriminator in the GAN framework during the training of the policy neural network. As a particular example, the policy network and the discriminator network can have been trained jointly through model-based generative adversarial imitation learning (MGAIL) on training data generated from observed trajectories of agents in the real-world environment and training data generated from simulated trajectories. For example, during the joint training, the system or the training system can have generated the simulated trajectories using the process 200.

As another particular example, the discriminator neural network can have been trained to optimize a generative adversarial imitation learning (GAIL) objective on training data generated from observed trajectories of agents in the real-world environment and training data generated from simulated trajectories. For example, during the training, the system or the training system can have generated the simulated trajectories using the process 200.

The system then generates the time step score from the discriminator score, e.g., by directly using the discriminator scores as the time step score or by applying a specified function to the discriminator scores, e.g., computing the logarithm of the discriminator score, computing the negative of the discriminator score, normalizing the discriminator score, and so on.

The system aggregates the respective time step scores for the interactive agents to determine the respective score for the partial trajectory (step 406). That is, the respective score for the partial trajectory is a combination of the time step scores for the interactive agents for the time steps after the most recent pruning time step.

As a particular example, the system can determine, for each interactive agent, a first summary statistic of the time step scores for the interactive agent and then determine the respective score for the partial trajectory by computing a second summary statistic of the first summary statistics for the interactive agents. The first and second summary statistic can be the same or can be different and can be any appropriate statistic that summarizes a set of numeric values.

As a particular example, the first summary statistic of the time step scores can be the maximum or minimum of the time step scores, i.e., depending on whether higher time step scores indicate that the criteria are more or less likely to be satisfied, and the second summary statistic of the summary statistics can be the average of the first summary statistics.

Pruning based on aggregate scores means that the simulation at a given timestep can be subtly influenced by future events, i.e., actions are pruned away because they lead to unrealistic future states.

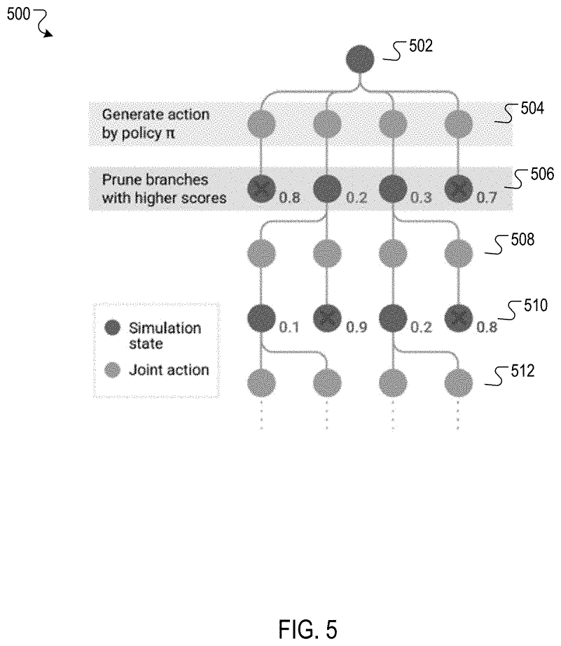

FIG. 5 shows an example of generating a set (“a beam”) of partial trajectories.

In the example of FIG. 5, the beam of partial trajectories includes four trajectories.

In particular, as shown in FIG. 5, each partial trajectory begins at the same initial environment state 502. For example, the initial state can correspond to an initial state in an existing trajectory, e.g., a real-world trajectory or a simulated trajectory, or can have been generated by the simulator at random or to satisfy one or more criteria, e.g., to model a desired driving scenario

Starting from the initial state, the system selects four joint actions 504 as described above.

The system then obtains, for each joint action and using the transition function for the simulated environment, next state data 506 characterizing a next state of the environment at a next time step given that the joint action is performed by the plurality of agents when the simulated environment is in the initial state. This results in four partial trajectories that each include a selected joint action and the next state data characterizing the next state of the environment at the next time step given the selected action.

In the example of FIG. 5, each time step is a pruning time step. Therefore, at the first time step, the system determines a respective score for each of the four partial trajectories and determines to “prune”, i.e., remove from the set, the two partial trajectories having the highest scores (0.8 and 0.7, respectively). The system then replaces the pruned trajectories with copies of each of the two remaining trajectories so that the set still includes four total partial trajectories.

The system then updates each of the partial trajectories in the beam at the second time step, i.e., by selecting a joint action 508 given the next state of the environment for the partial trajectory and obtaining next state data 510 given that the joint action was performed when the environment was in the next state.

After updating the four partial trajectories at the second time step, the system again determines a respective score for each of the four partial trajectories and determines to “prune”, i.e., remove from the set, the two partial trajectories having the highest scores (0.9 and 0.8, respectively). The system then replaces the pruned trajectories with copies of each of the two remaining trajectories so that the set still includes four total partial trajectories.

By continuing to iteratively expand and prune the partial trajectories in this manner, the system can generate multiple diverse, realistic trajectories starting from the initial state.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, off-the-shelf or custom-made parallel processing subsystems, e.g., a GPU or another kind of special-purpose processing subsystem. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A method performed by one or more computers, the method comprising:
obtaining initial state data specifying an initial state of a simulated environment that includes a plurality of simulated agents at an initial time step, wherein the simulated environment is a simulation of a real-world environment; and
generating a plurality of simulated trajectories that each start from the initial state of the simulated environment and each comprise, for each of a sequence of a plurality of time steps starting from the initial time step and until a final time step, (i) state data characterizing a state of the simulated environment at the time step and (ii) a respective action performed by each of the plurality of simulated agents at the time step, wherein the sequence of time steps includes a plurality of pruning time steps, and wherein the generating comprises, at each particular time step in the sequence:
obtaining data specifying a set of partial trajectories as of the particular time step that each include respective state data for the particular time step that characterizes a respective state of the simulated environment at the particular time step;
for each partial trajectory:
generating, from the respective state data for the particular time step in the partial trajectory, a joint policy output that specifies joint action that includes a respective action for each of the plurality of agents;
obtaining, using a transition function for the simulated environment, next state data characterizing a next state of the environment at a next time step given that the joint action is performed by the plurality of agents when the simulated environment is in the respective state characterized by the respective state data at the particular time step in the partial trajectory;
updating the partial trajectory to include the joint action for the particular time step and the next state data characterizing the next state of the environment at the next time step;
when the particular time step is a pruning time step:
determining a respective score for each partial trajectory that represents a likelihood that the partial trajectory satisfies one or more criteria for the simulated trajectories; and
removing one or more partial trajectories from the set of partial trajectories based on the respective scores.

2. The method of claim 1, wherein the generating comprises, at each particular time step in the sequence:
when the particular time step is a pruning time step:
for each of the one or more partial trajectories that were removed from the set, replacing the partial trajectory in the set with a copy of one of the partial trajectories that was not removed from the set.

3. The method of claim 1, wherein one or more of the simulated agents are designated as interactive agents, and wherein generating, from respective state data for the particular time step in the partial trajectory, a joint policy output comprises:
for each interactive agent:
generating, from the respective state data at the particular time step, a policy input that characterizes the respective state of the simulated environment at the particular time step relative to the interactive agent; and
processing the policy input using a policy neural network to generate a policy output that defines a next action to be performed by the interactive agent at the particular time step.

4. The method of claim 3, wherein all of the simulated agents are designated as interactive agents.

5. The method of claim 1, wherein the initial state of the simulated environment corresponds to a reference initial state of (i) the real-word environment or (ii) the simulated environment at an initial time step in a reference trajectory, and wherein each of the plurality of simulated agents corresponds to (i) a different real-world agent in the reference initial state of the real-world environment or (ii) a different simulated agent in the reference initial state of the simulated environment.

6. The method of claim 5, wherein only a proper subset of the simulated agents are designated as interactive agents, and wherein, for each of one or more agents that are not an interactive agent, the joint action assigns to the agent the action performed by the corresponding agent in the reference environment at a time step in the reference trajectory that corresponds to the particular time step.

7. The method of claim 3, wherein the policy input comprises data representing a goal to be performed by the agent during the simulated trajectory.

8. The method of claim 7, further comprising:
for each interactive agent, generating from the data specifying the initial state a goal input for the agent that characterizes the initial state of the simulated environment relative to the interactive agent;
processing the goal input using a goal generating policy neural network to generate a score distribution over a set of possible goals to be performed by the agent; and
selecting the goal to be performed by the agent from the set of possible goals using the scores.

9. The method of claim 7, wherein the goal to be performed by the agent is a route to be traveled by the agent over the sequence of time steps in the simulated trajectory, and wherein the set of possible goals is a set of possible routes for the agent.

10. The method of claim 9, wherein the route to be traveled is represented as a sequence of roadgraph lane segments starting at a lane segment corresponding to an initial state of the agent when the simulated environment is in the initial state.

11. The method of claim 8 wherein the goal generating policy neural network has been trained to match a distribution of goals occurring in training data generated from observed trajectories of agents in the real-world environment.

12. The method of claim 3, wherein determining a respective score for each partial trajectory that represents a likelihood that the partial trajectory satisfies one or more criteria for the simulated trajectories comprises:
for each time step after a most recent pruning time step, determining a respective time step score for each interactive agent from the next state data that was added to the partial trajectory at the time step; and
aggregating the respective time step scores for the interactive agents to determine the respective score for the partial trajectory.

13. The method of claim 12, wherein aggregating the respective time step scores for the interactive agents to determine score for each partial trajectory comprises:
for each interactive agent, determining a first summary statistic of the time step scores for the interactive agent; and
determining the respective score for the partial trajectory as a second summary statistic of the first summary statistics for the interactive agents.

14. The method of claim 13, wherein the first summary statistic of the time step scores is the maximum or minimum of the time step scores and the second summary statistic of the summary statistics is the average of the first summary statistics.

15. The method of claim 12, wherein determining a respective time step score for each interactive agent from the next state data that was added to the partial trajectory at the time step comprises:
generating from the next state data that was added to the partial trajectory at the time step a discriminator input for the interactive agent that characterizes the respective next state of the simulated environment relative to the interactive agent;
processing the discriminator input using a discriminator neural network that is configured to process the discriminator input to generate as output a discriminator score that represents a likelihood that the discriminator input was generated from state data characterizing an observed state of the real-world environment rather than a state of the simulated environment; and
generating the time step score from the discriminator score.

16. The method of claim 3 wherein the policy neural network has been trained through behavior cloning on at least training data generated from observed trajectories of agents in the real-world environment.

17. The method of claim 16, wherein the policy neural network has been trained through behavior cloning on training data generated from observed trajectories of agents in the real-world environment and training data generated from simulated trajectories.

18. The method of claim 3, wherein the policy neural network has been trained through model-based generative adversarial imitation learning (MGAIL) on training data generated from observed trajectories of agents in the real-world environment and training data generated from simulated trajectories.

19. The method of claim 18, wherein a discriminator neural network has been trained through MGAIL jointly with the policy neural network.

20. The method of claim 16 wherein the discriminator neural network has been trained to optimize a generative adversarial imitation learning objective on training data generated from observed trajectories of agents in the real-world environment and training data generated from simulated trajectories.

21. The method of claim 1 wherein removing one or more partial trajectories from the set of partial trajectories based on the respective scores comprises:
removing a threshold number of partial trajectories that have the worst respective scores.

22. The method of claim 1, wherein the state data characterizing the state of the environment at any given time step comprises (i) static scene features of the simulated environment (ii) dynamic scene features of the simulated environment at the given time step and (iii) respective state features for each of the simulated agents at the given time step.

23. The method of claim 1, wherein one of the simulated agents is controlled by control software for an autonomous vehicle while generating the simulated trajectories.

24. The method of claim 23, wherein one of the simulated agents is an ego agent, the state data for any given time step comprises data that represents data generated from data captured by sensors of the ego agent at the given time step, and wherein the ego agent is controlled by the control software for the autonomous vehicle.

25. The method of claim 1, further comprising:
evaluating a performance of control software for an autonomous vehicle using the simulated trajectories.

26. The method of claim 1, further comprising:
training one or more neural networks on training data generated from at least the plurality of simulated trajectories; and
deploying the one or more trained neural networks on-board an autonomous vehicle for use in controlling the autonomous vehicle as the vehicle navigates through the real-world environment.

27. A system comprising one or more computers and one or more storage devices storing instructions that when executed by the one or more computers cause the one or more computers to perform operations comprising:
obtaining initial state data specifying an initial state of a simulated environment that includes a plurality of simulated agents at an initial time step, wherein the simulated environment is a simulation of a real-world environment; and
generating a plurality of simulated trajectories that each start from the initial state of the simulated environment and each comprise, for each of a sequence of a plurality of time steps starting from the initial time step and until a final time step, (i) state data characterizing a state of the simulated environment at the time step and (ii) a respective action performed by each of the plurality of simulated agents at the time step, wherein the sequence of time steps includes a plurality of pruning time steps, and wherein the generating comprises, at each particular time step in the sequence:
obtaining data specifying a set of partial trajectories as of the particular time step that each include respective state data for the particular time step that characterizes a respective state of the simulated environment at the particular time step;
for each partial trajectory:
generating, from the respective state data for the particular time step in the partial trajectory, a joint policy output that specifies joint action that includes a respective action for each of the plurality of agents;
obtaining, using a transition function for the simulated environment, next state data characterizing a next state of the environment at a next time step given that the joint action is performed by the plurality of agents when the simulated environment is in the respective state characterized by the respective state data at the particular time step in the partial trajectory;
updating the partial trajectory to include the joint action for the particular time step and the next state data characterizing the next state of the environment at the next time step;
when the particular time step is a pruning time step:
determining a respective score for each partial trajectory that represents a likelihood that the partial trajectory satisfies one or more criteria for the simulated trajectories; and
removing one or more partial trajectories from the set of partial trajectories based on the respective scores.

28. One or more non-transitory computer-readable media storing instructions that when executed by one or more computers cause the one or more computers to perform operations comprising:
obtaining initial state data specifying an initial state of a simulated environment that includes a plurality of simulated agents at an initial time step, wherein the simulated environment is a simulation of a real-world environment; and
generating a plurality of simulated trajectories that each start from the initial state of the simulated environment and each comprise, for each of a sequence of a plurality of time steps starting from the initial time step and until a final time step, (i) state data characterizing a state of the simulated environment at the time step and (ii) a respective action performed by each of the plurality of simulated agents at the time step, wherein the sequence of time steps includes a plurality of pruning time steps, and wherein the generating comprises, at each particular time step in the sequence:
obtaining data specifying a set of partial trajectories as of the particular time step that each include respective state data for the particular time step that characterizes a respective state of the simulated environment at the particular time step;
for each partial trajectory:
generating, from the respective state data for the particular time step in the partial trajectory, a joint policy output that specifies joint action that includes a respective action for each of the plurality of agents;
obtaining, using a transition function for the simulated environment, next state data characterizing a next state of the environment at a next time step given that the joint action is performed by the plurality of agents when the simulated environment is in the respective state characterized by the respective state data at the particular time step in the partial trajectory;
updating the partial trajectory to include the joint action for the particular time step and the next state data characterizing the next state of the environment at the next time step;
when the particular time step is a pruning time step:
determining a respective score for each partial trajectory that represents a likelihood that the partial trajectory satisfies one or more criteria for the simulated trajectories; and
removing one or more partial trajectories from the set of partial trajectories based on the respective scores.
